(19) United States
(12) Patent Application Publication
(10) Pub. No.: US 2021/0052966 A1
(43) Pub. Date: Feb. 25, 2021

(54) WEARABLE SPORTS GARMENT FOR A GAME ON A PLAYING FIELD

(71) Applicant: Fraunhofer-Gesellschaft zur Förderung der angewandten Forschung e.V., München (DE)

(72) Inventor: Matthias Lochmann, Neunkirchen am Brand (DE)

(21) Appl. No.: 15/776,236

(22) PCT Filed: Nov. 14, 2016
(86) PCT No.: PCT/EP2016/077613

§ 371 Date: Oct. 23, 2020

(30) Foreign Application Priority Data
Nov. 19, 2015 (DE) 10 2015 120 078.3

(51) Int. Cl. A63B 71/06; H05B 45/20; A63B 24/00

(52) U.S. Cl. CPC A63B 71/0605; A63B 24/0062; H05B 45/20

(57) ABSTRACT

The present disclosure relates to a wearable sports garment for a game on a playing field, comprising: a controllable display arrangement configured to change a display characteristic depending on a control signal; and a wireless communication interface configured to receive the control signal for controlling the controllable display arrangement.

### CROSS-REFERENCE TO RELATED APPLICATIONS

This application is a 371 national phase filing of International Application No. PCT/EP2016/077613, entitled “WEARABLE SPORTS GARMENT FOR A GAME ON A PLAYING FIELD”, filed 14 Nov. 2016, which claims priority to German Patent Application No. 10 2015 120 078.3, entitled “TRAGBARE SPORTBEKLEIDUNG FUR EIN SPIEL AUF EINEM SPIELFELD”, filed 19 Nov. 2015.

### BACKGROUND

The disclosure relates to a wearable sports garment for a game on a playing field.

Games with a plurality of players on a playing field, for example, ball games such as soccer, volleyball or basketball, often require a rapid adjustment of the players to different game situations. However, it is often difficult to quickly pass on information from a coach to the players or between the players.

### SUMMARY

It is an object of the present disclosure to assist in the execution of a game on a playing field, for example, a ball game such as a soccer, volleyball or basketball game.

The above object is achieved by the features of the independent claims. Advantageous examples are the subject matter of the dependent claims, the description and the appended drawings.

According to a first aspect, the disclosure relates to a wearable sports garment for a game on a playing field, comprising: a controllable display arrangement which is configured to change a display characteristic depending on a control signal; and a wireless communication interface which is configured to receive the control signal for controlling the controllable display arrangement.

In an example, the disclosure relates to the wearable sports garment which comprises at least one wearable belt, wherein the controllable display arrangement and the wireless communication interface are integrated in the wearable belt.

In an example, the disclosure relates to the wearable sports garment, wherein the controllable display arrangement comprises a light element or a plurality of light elements, in particular LEDs.

In an example, the disclosure relates to the wearable sports garment, wherein the controllable display arrangement is configured to change at least one of the following display characteristics of the light elements: a light frequency, a light color, a light intensity, depending on the control signal and/or depending on a recorded number of steps.

In an example, the disclosure relates to the wearable sports garment, wherein the controllable display arrangement is configured to switch off precisely a light element in response to the reception of the control signal or after the expiration of a predetermined time interval or depending on a number of steps.

In an example, the disclosure relates to the wearable sports garment which further comprises a pedometer for recording a number of steps, wherein the controllable display arrangement is configured to change the display characteristic depending on the recorded number of steps.

In an example, the disclosure relates to the wearable sports garment, wherein the display arrangement further comprises a controllable acoustic signal generator which is configured to emit an acoustic signal or to change a display characteristic of the acoustic signal, in particular, a signal frequency, a signal sequence, a signal loudness, a signal form or a signal pattern, in response to a reception of a control signal by the communication interface.

In an example, the disclosure relates to the wearable sports garment which further comprises a vibration module which is configured to emit a vibration signal in response to the reception of the control signal by the communication interface.

In an example, the disclosure relates to the wearable sports garment, wherein the control signal indicates a position of the player on the playing field or a position of the player relative to a position of another player or a position of a game object on the playing field, in particular in a predetermined area or zone of the playing field, or a position of the game object relative to the game apparatus or a position of the game object relative to a position of the player or of another player, or wherein the control signal indicates the position of the game object and the position of the player.

The game object can be a sports object, for example, a ball.

In an example, the disclosure relates to the wearable sports garment, wherein the control signal indicates a display characteristic of the display arrangement and wherein the display arrangement is configured to change the display characteristic depending on the control signal.

In an example, the disclosure relates to the wearable sports garment, wherein the control signal indicates a game rule or a change of a game rule or a playing field boundary or a change of a playing field boundary.

In an example, the disclosure relates to the wearable sports garment, wherein the control signal further indicates a physiological parameter, in particular, a performance physiological parameter of the player or of an opponent.

In an example, the disclosure relates to the wearable sports garment, wherein the display arrangement is configured to change the display characteristic after the expiration of a predetermined or adjustable time interval.

The display arrangement can further be configured to change a characteristic of a display signal after the expiration of a predetermined or adjustable interval.

In an example, the disclosure relates to the wearable sports garment, wherein the communication interface is configured to work according to one of the following communication technologies: Bluetooth, WLAN, UMTS, LTE, Ethernet, Internet, RFID.

According to a second aspect, the disclosure relates to a control apparatus for controlling the display arrangement of the wearable sports garment according to the first aspect, comprising a graphic user interface for entering the display characteristic of the display arrangement, in order to generate a control signal, and a communication interface for transmitting the control signal via a communication network, in particular via Bluetooth, WLAN, UMTS, LTE, Ethernet, Internet, RFID, to the wearable sports garment.

### BRIEF DESCRIPTION OF THE DRAWINGS

Examples of the present disclosure are explained in reference to the enclosed drawings.

FIG. 1 shows a wearable sports garment.

### DETAILED DESCRIPTION

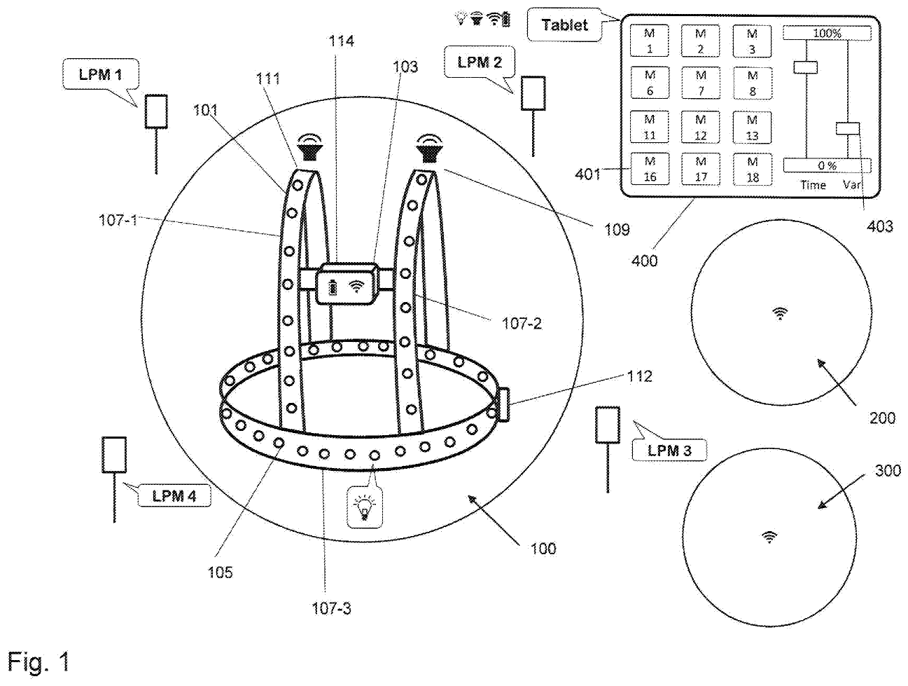

FIG. 1 shows a wearable sports garment 100 for a game on a playing field, comprising a controllable display arrangement 101 which is configured to change a display characteristic depending on a control signal, and a wireless communication interface 103 which is configured to receive the control signal for controlling the controllable display arrangement 101. The display arrangement 101 can be a light arrangement. The display arrangement 101 can comprise a plurality of light elements 105, in particular LEDs. The wearable sports garment 100 can be, for example, in the form of a T-shirt or a jersey.

The wearable sports garment 100 can further comprise a belt 107-1, 107-2, 107-3 of a belt system 107-1, 107-2, 107-3. The wearable sports garment 100 as well as the communication interface 103 can be embedded in the belt 107-1, 107-2, 107-3. The belt 107-1, 107-2, 107-3 can comprise two shoulder belts 107-1, 107-2 as well as a waist belt 107-3. The belt 107-1, 107-2, 107-3 can be of any form.

The wearable sports garment 100 can further comprise one or more acoustic signal generators 109, for example loudspeakers, and/or one or more vibration generators or vibration modules 111 and/or a pedometer 112 and/or an energy storage device 114 for the energy supply.

In FIG. 1, by way of example, further wearable sports garments 200, 300 are shown, which can comprise the features of the wearable sports garment 100. Furthermore, a control apparatus 400 is shown in FIG. 1.

The wearable sports garment 100, for example, a SMART iShirt, comprises the belt system 107-1, 107-2, 107-3, RGB LEDs 105 and small loudspeakers 109 which can be controlled via a Smartphone, a PC or another radio-supported control unit. Depending on certain states which can be represented by the control signal, the LEDs 105 and/or the mini loudspeakers 109 can assume certain optical or acoustic states.

These optical or acoustic states can be: a permanent lighting in a certain color (“the electronic jersey”), a blinking lighting in a certain color or in different colors, a sound of any type, for example, voice messages or signal tones, or any combination of the above-described states.

The states which determine the optical and acoustic display characteristic of the display arrangement 101 of the wearable sports garment 100 can basically be fixed instructions, for example, adjusted by a coach using a smartphone. The fixed instructions can be, for example, that: the shirt should change color every 30 seconds or at other time intervals, for example, for the indication of new teammates, the color is synchronized with certain goals, the color is selected depending on the playing ability of a player, wherein the playing ability of each player can be stored in a cloud memory, the left side has a different color from the right side (players may have the ball passed to them only on the side of “green” color), the LEDs are switched off so that players can be taken out of the game, the mini loudspeakers emit certain signal tones or voice messages (open key signals), the vibration modules 111 transmit certain vibration signals (hidden key signals).

Furthermore, the states which determine the optical and acoustic display characteristic of the display arrangement 101 of the wearable sports garment 100 can be dynamic instructions controlled, for example, by expert knowledge implemented in the system.

The described states of the wearable sports garment 100 can be made dynamic and be made depending on defined rules, in particular, expert knowledge of coaches, sports physicians or training scientists, which is implemented in the system or in the control apparatus 400, on position data of the teammates, opponents and of the ball as well as on physiological states of the teammates and opponents. Examples for a dynamic control of the states of the wearable sports garment 100 are shown in the following:
(i) If two teams with an even number of players and opponents are playing, for example, three against three, then an additional wearable sports garment 200, 300 of a player not playing at that time is activated, for example, by activating a light element 101 as soon as the opposing team takes the lead with more than two goals. Thus, the losing team then plays with one more player. The state of the game can be manually tracked by the coach or can be monitored automatically by the system.
(ii) A signal of a light element 101 of a wearable sports garment 100 is deactivated when the player wearing the wearable sports garment 100 does not stay in a predetermined zone. Thus, the player can be removed electronically from the game, if he does not comply with an instruction, for example, an instruction to play only in the attack zone or only in the shooting zone. The position data of the player can be monitored in real time with a localization system (RedFIR, Catapult, video, etc.).
(iii) If a goal is scored, then each wearable sports garment 100, 200, 300 of the wearer who has been in the field for the longest time up to then and/or who has taken the most steps since the last goal switches its LEDs 105 off. At the same time, each wearable sports garment 100, 200, 300 of the wearer who has taken a break for the longest time is switched on, whereby an electronic rotation management can be achieved. The duration can be monitored by the control apparatus 400. The steps can be monitored in real time by an incorporated pedometer 112 or a GPS or LPM system, for example, LPM 1-4 in FIG. 1.
(iv) If a player is located in a cover shadow, then each wearable sports garment 100, 200, 300 of a wearer to which this condition applies switches its LEDs off (marking of unguarded player). The position data of the player and of the ball can be monitored in real time with the localization system (RedFIR, Catapult, video, etc.) and used for the control of the characteristic.

The control apparatus 400 is used for controlling the display arrangement 101 of the wearable sports garment 100, 200, 300 and is provided with a graphic user interface 401 for entering or selecting the display characteristic of the display arrangement 101, in order to generate the control signal, and with a communication interface for transmitting the control signal via a communication network to the wearable sports garment 100, 200, 300.

The graphic user interface 401 can comprise selection elements 403 by means of which, for example, the light colors of the LEDs 105 of the respective wearable sports garment 100, 200, 300 can be selected or activated.

### LIST OF REFERENCE NUMBERS

100 Wearable sports garment
101 Display arrangement
103 Communication interface
105 Light element
107-1 Belt
107-2 Belt
107-3 Belt
109 Acoustic signal generator
111 Vibration module
112 Pedometer
114 Energy storage device
200 Additional wearable sports garment
300 Additional wearable sports garment
400 Control apparatus
401 User interface
403 Selection element

What is claimed is:

1. A wearable sports garment for a game on a playing field, comprising:
a controllable display arrangement configured to change a display characteristic depending on a control signal; and
a wireless communication interface configured to receive the control signal for controlling the controllable display arrangement.

2. The wearable sports garment according to claim 1, further comprising:
at least one wearable belt, wherein the controllable display arrangement and the wireless communication interface are integrated in the wearable belt.

3. The wearable sports garment according to claim 1, wherein the controllable display arrangement comprises a light element.

4. The wearable sports garment according to claim 3, wherein the controllable display arrangement is configured to change at least one of the following display characteristics of the light element: a light frequency, a light color, or a light intensity; wherein the change is dependent on the control signal, or a recorded number of steps, or a combination thereof.

5. The wearable sports garment according to claim 3, wherein the controllable display arrangement is configured to switch off the light element in response to a reception of the control signal, after expiration of a predetermined time interval, or depending on a number of steps.

6. The wearable sports garment according to claim 1, further comprising:
a pedometer configured to record a number of steps, wherein the controllable display arrangement is configured to change the display characteristic depending on the recorded number of steps.

7. The wearable sports garment according to claim 1, wherein the controllable display arrangement further comprises a controllable acoustic signal generator configured to emit an acoustic signal or to change a display characteristic of the acoustic signal in response to a reception of the control signal by the wireless communication interface.

8. The wearable sports garment according to claim 1, further comprising:
a vibration module configured to emit a vibration signal in response to a reception of the control signal by the wireless communication interface.

9. The wearable sports garment according to claim 1, wherein the control signal indicates a position of a player on the playing field, or a position of the player relative to a position of another player, or a position of a game object on the playing field, or a position of the game object relative to a game apparatus, or a position of the game object relative to a position of the player or of another player, or the position of the game object and the position of the player.

10. The wearable sports garment according to claim 1, wherein the control signal indicates the display characteristic of the controllable display arrangement.

11. The wearable sports garment according to claim 1, wherein the control signal indicates a game rule, or a change of a game rule, or a playing field boundary, or a change of a playing field boundary.

12. The wearable sports garment according to claim 1, wherein the control signal indicates a physiological parameter of a player or of an opponent.

13. The wearable sports garment according to claim 1, wherein the controllable display arrangement is configured to change the display characteristic after expiration of a predetermined or adjustable time interval.

14. The wearable sports garment according to claim 1, wherein the wireless communication interface is configured to work according to one of the following communication technologies: Bluetooth, WLAN, UMTS, LTE, Ethernet, Internet, or RFID.

15. The wearable sports garment according to claim 1, further comprising:
a control apparatus configured to control the controllable display arrangement of the wearable sports garment, comprising:
a graphic user interface configured to enter the display characteristic of the controllable display arrangement to generate the control signal; and
a communication interface configured to transmit the control signal via a communication network to the wearable sports garment.

16. The wearable sports garment according to claim 3, wherein the light element comprises a light emitting diode (LED).

17. The wearable sports garment according to claim 7, wherein the display characteristic of the acoustic signal comprises at least one of: a signal frequency, a signal sequence, a signal loudness, a signal form, or a signal pattern.

18. The wearable sports garment according to claim 9, wherein the position of the game object on the playing field comprises a predetermined area or zone of the playing field.

19. The wearable sports garment according to claim 12, wherein the physiological parameter comprises a performance physiological parameter of the player or of the opponent.

20. The wearable sports garment according to claim 15, wherein the graphic user interface comprises selection elements corresponding to each of a plurality of wearable sports garments.
